(19) United States
(12) Patent Application Publication
(10) Pub. No.: US 2017/0201974 A1
(43) Pub. Date: Jul. 13, 2017

(54) RANDOM ACCESS METHOD AND DEVICE IN MOBILE COMMUNICATION SYSTEM

(71) Applicant: ELECTRONICS AND TELECOMMUNICATIONS RESEARCH INSTITUTE, Daejeon (KR)

(72) Inventors: Kyung Yeol SOHN, Daejeon (KR); Jisoo PARK, Daejeon (KR); Hoon LEE, Daejeon (KR)

(73) Assignee: ELECTRONICS AND TELECOMMUNICATIONS RESEARCH INSTITUTE, Daejeon (KR)

(21) Appl. No.: 15/223,369

(22) Filed: Jul. 29, 2016

(30) Foreign Application Priority Data
Jan. 12, 2016 (KR) 10-2016-0003857

(51) Int. Cl. H04W 72/04; H04W 74/00

(52) U.S. Cl. CPC H04W 72/046; H04W 74/008; H04W 74/004; H04W 72/0413; H04W 72/048; H04L 5/0023

(57) ABSTRACT

A base station uses a plurality of transmitting/receiving beams to divide a service region into a plurality of sub-regions, transmits a sub-region reference signal for identifying sub-regions and a beam-identifying reference signal for identifying transmitting/receiving beams in sub-regions, uses transmitting beams belonging to sub-regions to transmit a system information block including random access information of sub-regions, uses random access information of the sub-region to which the terminal belongs to receive a random access preamble transmitted by the terminal and determine the transmitting/receiving beam to which the terminal belongs, and transmits a random access response message including resource allocation information of the transmitting/receiving beam to which the terminal belongs to the terminal.

### CROSS-REFERENCE TO RELATED APPLICATION

This application claims priority to and the benefit of Korean Patent Application No. 10-2016-0003857 filed in the Korean Intellectual Property Office on Jan. 12, 2016, the entire contents of which are incorporated herein by reference.

### BACKGROUND OF THE INVENTION

(a) Field of the Invention

The present invention relates to a random access method and device in a mobile communication system. More particularly, the present invention relates to a random access method and device in a millimeter wave-based multi-beam mobile communication system.

(b) Description of the Related Art

Regarding the mobile communication system such as the long term evolution (LTE) or the LTE-advanced (LTE-A), a terminal performs a random access process so as to perform an initial access to a base station, uplink synchronization for setting a connection with a network, and a request on allocation of an uplink resource. When the uplink synchronization between the base station and the terminal is not acquired, no uplink data may be transmitted so the main purpose of the random access process is to acquire the uplink synchronization.

Regarding the random access process of the LTE/LTE-A, the terminal having finished a cell search using a synchronization signal transmitted by the base station uses random access information included in a system information block (SIB) and transmits a random access preamble so as to estimate transmission timing of the terminal. When receiving the random access preamble, the base station includes a transmission timing offset for the terminal to control the transmission timing and uplink resource allocation information into a random access response (RAR) message and transmits the same to the terminal. When receiving a valid RAR message, the terminal transmits a connection request message including an identifier of the terminal to the base station, and a content of the transmitted connection request message depends on a state of the terminal, particularly, the state of whether the terminal is known to the network. When receiving the connection request message from the terminal, the base station transmits a contention resolution message to the terminal to thus finish the random access process.

However, to satisfy the wireless data traffic demands that have recently continued to increase, a study for using a millimeter wave band that has sufficient usable frequency bandwidths has been actively progressed as a method for increasing a data rate of the mobile communication system. Usage of the millimeter wave band enables a system that may install many antennas, and also makes it possible to operate a 2D/3D beamforming base station system for using a plurality of antennas and focusing a service region of radio waves in a specific direction.

In the mobile communication system using millimeter wave-based multi-beams, the service region of the base station includes a plurality of transmitting/receiving beams, and the transmitting/receiving beams use an identical frequency bandwidth and time slot. A plurality of terminals belonging to the same beam receive orthogonal components that are divided in a time or frequency domain to communicate with the base station. Here, the transmitting beams used by the terminal have a wider radiation pattern than the precise transmitting/receiving beams used by the base station because of limits of physical spaces, performance, and cost.

When the above-configured mobile communication system uses the same random access process as the existing LTE/LTE-A system, the random access preambles transmitted by the terminals are received in a plurality of receiving beams provided to the base station so a time used for a random access is increased because of interference between signals. Further, when detection of random access preambles is finished, identical random access preambles may be detected from the receiving beams of the base station because of the wide radiation pattern of the terminal. Therefore, the base station may not exactly know to which transmitting/receiving beam of the base station the terminal having transmitted the random access preamble belongs. Also, when the base station transmits an RAR message to the terminal having transmitted the random access preamble in response to the random access preamble, it may not know which transmitting beam to use.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and device for processing a random access in a mobile communication system for increasing efficiency of a random access process in a millimeter wave-based mobile communication system.

An exemplary embodiment of the present invention provides a random access method by a base station for operating a plurality of transmitting/receiving beams in a service region. The random access method includes: dividing the service region into a plurality of sub-regions by using the plurality of transmitting/receiving beams; transmitting a system information block including random access information of the sub-regions by using transmitting beams belonging to the respective sub-regions; detecting a random access preamble transmitted by the terminal by using random access information of the sub-region to which the terminal belongs; determining a transmitting/receiving beam where the terminal is provided by using the random access preamble; and transmitting a random access response message including resource allocation information of the transmitting/receiving beam where the terminal is provided to the terminal.

The random access method may further include transmitting a sub-region reference signal including identifiers of the sub-regions and a beam-identifying reference signal including identifiers of the transmitting/receiving beams provided in the sub-regions.

Random access information of the sub-regions may include at least one index value allocated to the transmitting/receiving beam belonging to the sub-region and at least one a cyclic shift value allocated to the terminal, and the random access preamble may be generated by using an index value allocated to the transmitting/receiving beam to which the terminal belongs and the at least one cyclic shift value.

The detecting may include: generating random access preamble candidates by using an index value allocated to the transmitting/receiving beam to which the terminal belongs and at least one cyclic shift value allocated to the terminal; and detecting a random access preamble transmitted by the terminal by using the random access preamble candidates.

The detecting may include combining a signal received through at least one receiving beam of the sub-region to which the terminal belongs to detect the random access preamble.

The random access method may further include: receiving the connection request message transmitted by the terminal through the receiving beam of the beam region to which the terminal belongs by using resource allocation information included in the random access response message; and transmitting the collision resolution message to the terminal through the transmitting beam having a same identifier as the receiving beam.

Another embodiment of the present invention provides a random access method by a terminal. The random access method includes: acquiring a sub-region in which the terminal is provided and a transmitting/receiving beam by using transmitting beams belonging to a plurality of sub-regions belonging to a service region of a base station; receiving a system information block including random access information of the sub-region in which the terminal is provided; transmitting a random access preamble generated by using random access information of the sub-region in which the terminal is provided; and receiving a random access response message including resource allocation information of the transmitting/receiving beam to which the terminal belongs from the base station.

The acquiring may include: receiving a sub-region reference signal including identifiers of the plurality of sub-regions and a beam-identifying reference signal including identifiers of transmitting/receiving beams in the sub-regions from the base station; and acquiring an identifier of the sub-region in which the terminal is provided and an identifier of the transmitting/receiving beam by using the sub-region reference signal and the beam-identifying reference signal.

The transmitting of a random access preamble may include: determining random access information of a system information block corresponding to the identifier of the sub-region in which the terminal is provided; and selecting a random access preamble from among at least one random access preamble candidate generated by use of an index value allocated to the identifier of the transmitting/receiving beam where the terminal is provided by using the random access information.

The random access information may further include at least one cyclic shift value, and the selecting may include generating the at least one random access preamble candidate by using the index value and the at least one cyclic shift value.

The generating may further include generating the random access preamble by using a Zadoff-Chu (ZC) sequence.

The random access method may further include: transmitting a connection request message to the receiving beam where the terminal is provided by using resource allocation information included in the random access response message; and receiving a collision resolution message from the base station.

Yet another embodiment of the present invention provides a random access device for a base station operating a plurality of transmitting/receiving beams in a service region. The random access device includes a processor and a transceiver. The processor divides the service region into a plurality of sub-regions by using the plurality of transmitting/receiving beams, determines random access information of the sub-regions, determines a transmitting/receiving beam where the terminal is provided by using the random access preamble transmitted by the terminal based on random access information of the sub-region where the terminal is provided, and generates a random access response message including resource allocation information of the transmitting/receiving beam to which the terminal belongs. The transceiver transmits random access information of the sub-regions through transmitting beams of the sub-regions, receives the random access preamble from the terminal, and transmits the random access response message to the terminal.

The processor may identify usable indexes for respective sub-regions, may identify the indexes of the sub-regions for respective receiving beams provided in the sub-regions, and may generate a system information block of the sub-regions including an index value identified for receiving beams of the regions and at least one cyclic shift value allocated to the terminal, and the transceiver may transmit the system information block of the sub-regions through transmitting beams of the sub-regions.

The processor may generate a sub-region reference signal including identifiers of the sub-regions and a beam-identifying reference signal including identifiers of the transmitting/receiving beams provided in the sub-regions, the transceiver may transmit the sub-region reference signal and the beam-identifying reference signal to the terminal, and the random access preamble may be generated by using an index value allocated to the transmitting/receiving beam to which the terminal belongs and the at least one cyclic shift value.

The processor may determine the sub-region and the transmitting/receiving beam to which the terminal belongs based on an index value corresponding to the random access preamble.

### BRIEF DESCRIPTION OF THE DRAWINGS

FIG. 1 and FIG. 2 show a service region of a base station in a millimeter wave-based mobile communication system according to an exemplary embodiment of the present invention.

FIG. 3A and FIG. 3B show a random access process according to an exemplary embodiment of the present invention.

FIG. 4 shows a random access operation by a base station according to an exemplary embodiment of the present invention.

FIG. 5 shows a random access operation by a terminal according to an exemplary embodiment of the present invention.

FIG. 6 shows a random access device of a base station according to an exemplary embodiment of the present invention.

FIG. 7 shows a random access device of a terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

A terminal may designate a mobile terminal (MT), a mobile station (MS), an advanced mobile station (AMS), a high-reliability mobile station (HR-MS), a subscriber station (SS), a portable subscriber station (PSS), an access terminal (AT), or user equipment (UE), and it may include entire or part of functions of the MT, MS, AMS, HR-MS, SS, PSS, AT, and UE.

A base station (BS) may designate an advanced base station (ABS), a high-reliability base station (HR-BS), a node B, an evolved node B (eNodeB), an access point (AP), a radio access station (RAS), a base transceiver station (BTS), a mobile multihop relay (MMR)-BS, a relay station (RS) for functioning as the base station, a relay node (RN) for functioning as the base station, an advanced relay station (ARS) for functioning as the base station, a high-reliability relay station (HR-RS) for functioning as the base station, a femto base station (femto BS), a home node B (HNB), a home eNodeB (HeNB), a pico base station (pico BS), a metro base station (metro BS), or a micro base station (micro BS), and it may include entire or part of functions of the ABS, nodeB, eNodeB, AP, RAS, BTS, MMR-BS, RS, RN, ARS, HR-RS, and femto BS.

A random access method and device in a mobile communication system according to an exemplary embodiment of the present invention will now be described in detail with reference to accompanying drawings.

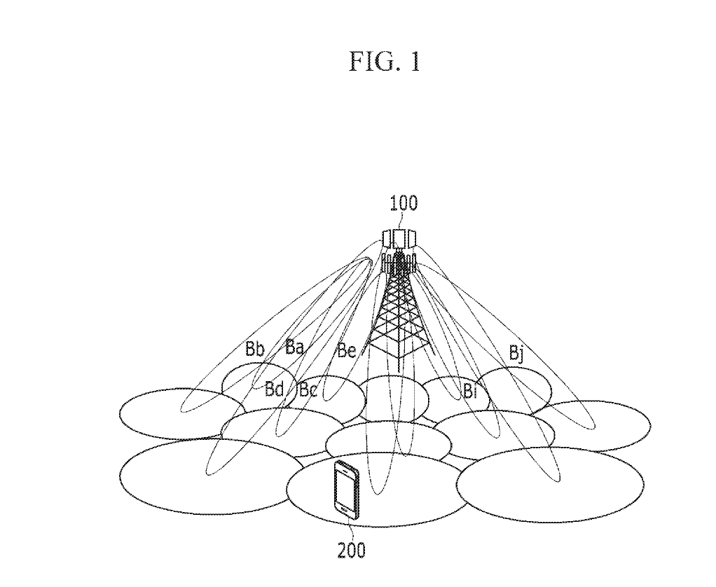

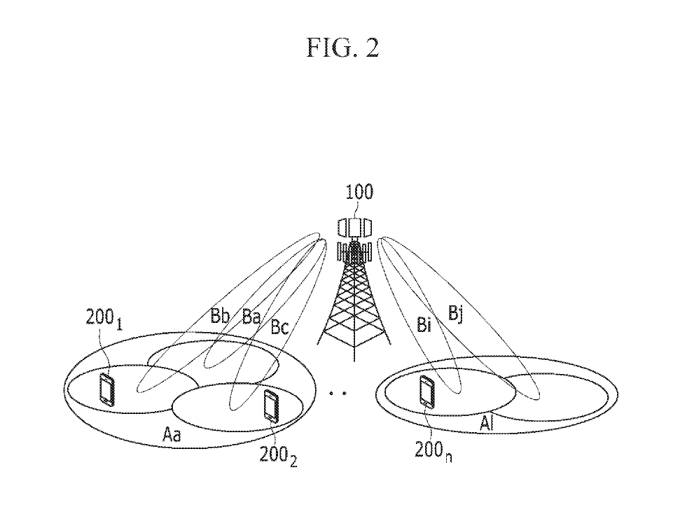

FIG. 1 and FIG. 2 show a service region of a base station 100 in a millimeter wave-based mobile communication system according to an exemplary embodiment of the present invention.

Referring to FIG. 1, in the millimeter wave-based mobile communication system, the base station 100 operates a plurality of transmitting/receiving beams (Ba, Bb, Bc, Bd, Be, . . . , Bi, Bj) in a cell. The plurality of transmitting/receiving beams (Ba, Bb, Bc, Bd, Be, . . . , Bi, Bj) may respectively have a unique beam identifier, and the transmitting/receiving beams (Ba, Bb, Bc, Bd, Be, . . . , Bi, Bj) may partly overlap adjacent beams.

The transmitting/receiving beams (Ba, Bb, Bc, Bd, Be, . . . , Bi, Bj) use the millimeter wave frequency that is greater than 10 GHz as a carrier frequency, and it may use the frequency that is over several hundreds of MHz to 1 GHz for the purpose of data transmission. Further, the transmitting/receiving beams (Ba, Bb, Bc, Bd, Be, . . . , Bi, Bj) use a same frequency bandwidth and a same time slot, and a plurality of terminals 200 belong to the same beam communicate with the base station 100 using orthogonal components divided in a time or frequency domain to communicate with the base station 100.

Referring to FIG. 2, the base station 100 uses a plurality of transmitting/receiving beams (Ba, Bb, Bc, Bd, Be, . . . , Bi, Bj) to divide the service region into a plurality of sub-regions (Aa, Ab, . . . , Al), and each of the sub-regions (Aa, Ab, . . . , Al) has at least one transmitting/receiving beam. For example, as shown in FIG. 2, the sub-region (Aa) may include three transmitting/receiving beams (Ba, Bb, and Bc), and the sub-region (Al) may include two transmitting/receiving beams (Bi and Bj).

To acquire downlink synchronization, the base station 100 transmits a synchronization signal identically applicable to the sub-regions (Aa, Ab, . . . , Al), a sub-region reference signal for identifying the sub-regions (Aa, Ab, . . . , Al), a beam-identifying reference signal for identifying transmitting/receiving beams in the sub-regions (Aa, Ab, . . . , Al), and a system information block (SIB) including random access information of the respective regions through all transmitting beams operated by the base station 100.

A plurality of terminals (200₁, 200₂, . . . , 200ₙ) included in the sub-regions (Aa, Ab, . . . , Al) use a synchronization signal transmitted by the base station 100 to acquire downlink synchronization, use a sub-region reference signal and a beam-identifying reference signal to determine the sub-region and the transmitting/receiving beam to which the same belong, and use the SIB including random access information of the sub-region to which the same belong to perform a random access process.

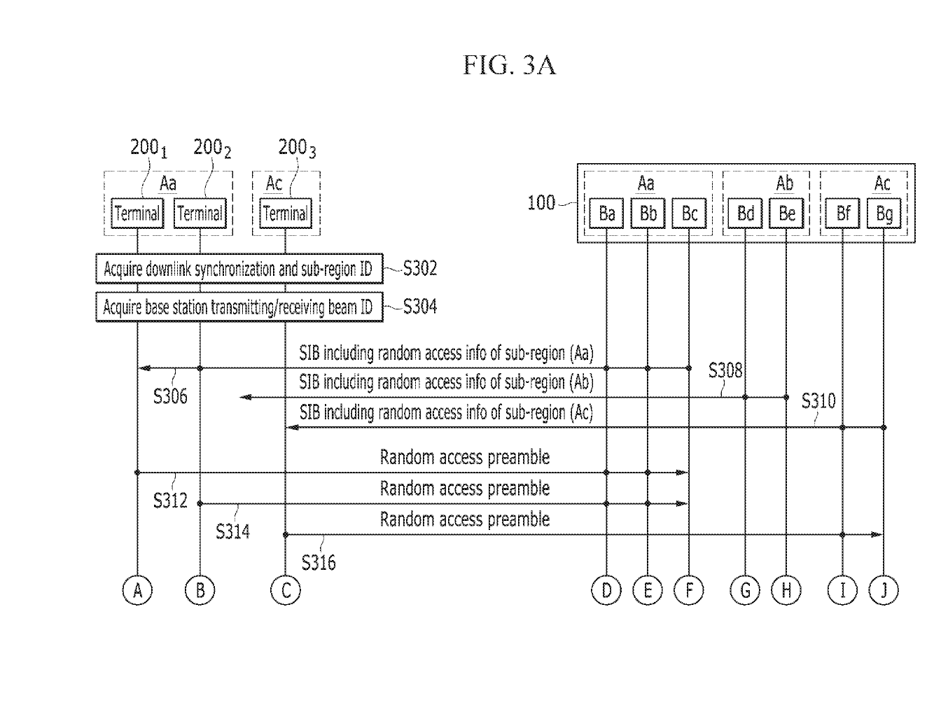

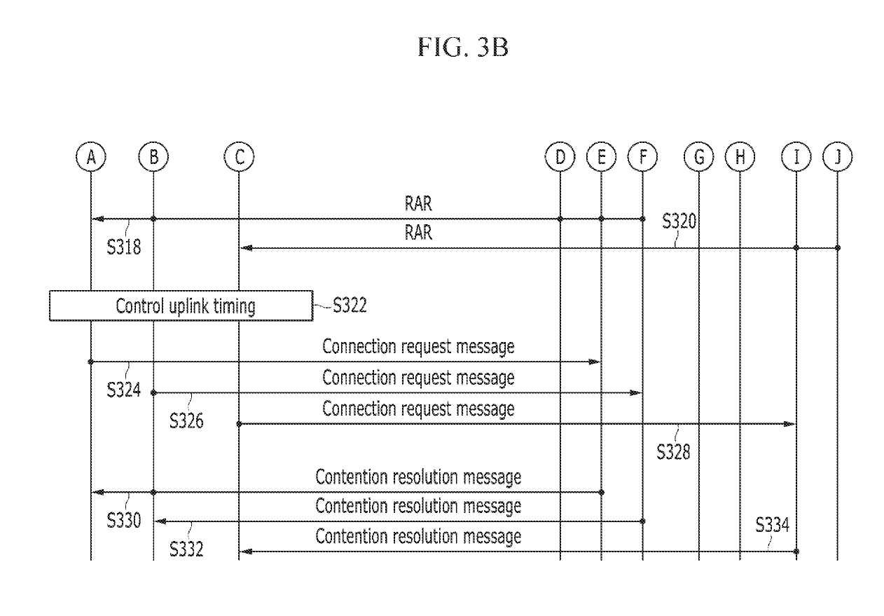

FIG. 3A and FIG. 3B show a random access process according to an exemplary embodiment of the present invention.

As shown in FIG. 3A, it is assumed that the service region of the base station 100 is divided into three sub-regions (Aa, Ab, and Ac), the sub-region (Aa) includes three transmitting/receiving beams (Ba, Bb, and Bc), the sub-region (Ab) includes two transmitting/receiving beams (Bd and Be), the sub-region (Ac) includes two transmitting/receiving beams (Bf and Bg), the terminals 200₁ and 200₂ belong to the sub-region (Aa), and the terminal 200₃ belongs to the region (Ac).

Referring to FIG. 3A, the terminals 200₁, 200₂, and 200₃ belonging to the service region of the base station 100 use a synchronization signal transmitted by the base station 100 to acquire downlink synchronization, and use a sub-region reference signal to acquire an identifier (ID) of the sub-region to which the terminals (200₁, 200₂, . . . , 200ₙ) belong (S302). The sub-region reference signal includes a sub-region ID, that is, information for identifying the sub-regions (Aa, Ab, . . . , Al).

The terminals (200₁, 200₂, . . . , 200ₙ) with the downlink synchronized with the base station 100 use the beam-identifying reference signal transmitted by the base station 100 to acquire the ID of the transmitting/receiving beam to which the terminals (200₁, 200₂, . . . , 200ₙ) belong (S304), and stand by for the SIB provided in the sub-regions.

The base station 100 transmits the SIB including random access information of each sub-region through the transmitting beam of the sub-region. The transmitting beams belonging to the same sub-region transmit the SIB including the same random access information. That is, the transmitting beams (Ba, Bb, and Bc) belonging to the sub-region (Aa) transmit the SIB including random access information of the sub-region (Aa) (S306), the transmitting beams (Bd and Be) belonging to the sub-region (Ab) transmit the SIB including random access information of the sub-region (Ab) (S308), and the transmitting beams (Bf and Bg) belonging to the sub-region (Ac) transmit the SIB including random access information of the sub-region (Ac) (S310). The random access information may include a number of random access preambles usable in the sub-region, at least one index for generating a random access preamble, and a preamble maximum transmission power for the beam.

The SIB's including random access information transmitted by the transmitting beams (Ba, Bb, Bc, Bd, Be, Bf, and Bg) belonging to different sub-regions (Aa, Ab, and Ac) are configured to minimize signal interference.

The terminals 200₁, 200₂, and 200₃ transmit the random access preamble to the base station 100 through a physical random access channel (PRACH) using random access information included in the SIB transmitted by the base station 100 (S312), (S314), and (S316). For example, the terminals 200₁ and 200₂ transmit the random access preamble using the SIB including random access information transmitted for the sub-region (Aa) to which the terminals 200₁ and 200₂ belong (S312) and (S314), and the terminal 200₃ transmit the random access preamble using the SIB including random access information transmitted for the sub-region (Ac) to which the terminal 200₃ belongs (S316).

The base station 100 receives the random access preamble from the terminals 200₁, 200₂, and 200₃ through the receiving beams of the corresponding sub-region.

A non-line-of-sight (NLOS) signal caused by a reflector may exist in addition to a line-of-sight (LOS) signal depending on a wide radiation pattern of the transmitting beam used by the terminals 200₁, 200₂, and 200₃ and a channel environment where the terminals 200₁, 200₂, and 200₃ are provided, and the base station 100 combines signals that are received through respective receiving beams belonging to the identical sub-region by use of a maximal ratio combining (MRC) scheme or an equal gain combining (EGC) scheme, to increase quality of the received signals and thus increase a detection probability of the random access preamble. When the terminals belonging to the same sub-region use different random access preambles, the base station 100 may use a result obtained by using a method such as the MRC or EGC scheme to identify the respective terminals. During the above-noted process, a code with an excellent correlation property may be used for generating the random access preamble so that the random access preamble transmitted by the terminal 200₃ belonging to the adjacent sub-region (e.g., sub-region (Ac)) may not be detected from the present sub-region (e.g., sub-region (Aa)). For example, the random access preamble transmitted through the PRACH may be generated by using a Zadoff-Chu (ZC) sequence used by the LTE/LTE-A and WiMAX system.

Further, in order to identify the receiving beams (Bb and Bc) to which the terminals 200₁ and 200₂ belong from among a plurality of receiving beams of the base station 100 provided in the present sub-region (e.g., sub-region (Aa)), the base station 100 may allocate at least one index to the terminals of the respective receiving beam regions to minimize collisions that may occur during the random access process of the terminals 200₁ and 200₂.

That is, when the number of indexes for generating the random access preamble is set, the base station 100 identifies usable indexes for respective sub-regions, and identifies the indexes of the sub-regions for respective receiving beams provided in the respective sub-regions. Index information identified for the respective receiving beams of the sub-regions may be included in the SIB transmitted through the transmitting beams of the respective sub-regions.

The terminals 200₁, 200₂, and 200₃ select one of the indexes allocated to generate the random access preamble corresponding to the ID of the transmitting/receiving beams to which the terminals 200₁, 200₂, and 200₃ belong, and transmit the random access preamble generated by use of the selected index. The terminals provided in the same transmitting/receiving beam region may transmit the same random access preamble. Therefore, a function such as a cyclic shift may be applied so as to minimize the collision that may be generated during the random access process of the terminals provided in the same receiving beam region. That is, the terminals belonging to the same transmitting/receiving beam region in the same sub-region arbitrarily select one of the random access preambles that may be generated by using index values and cyclic shift values, and then transmit the same. The cyclic shift values allocated to the terminals 200₁, 200₂, and 200₃ may be transmitted to the terminals 200₁, 200₂, and 200₃ from the base station 100 through an SIB Type 2.

The terminals belonging to the same transmitting/receiving beam region receive a same cyclic shift value by random access information. For example, when a random index value is provided for the random access preamble with a length of 16 corresponding to the ID of the transmitting/receiving beam, one random access preamble with a length of 16 is generated. In this instance, the cyclic shift value corresponds to 0. When an index value and a cyclic shift value of 4 are provided, four random access preambles are generated by the index value and the cyclic shift value, and the terminals belonging to the same transmitting/receiving beam arbitrarily select one of the four random access preambles and transmit the same to the base station 100. In a like manner, when two index values are provided and the cyclic shift value is provided as 4 corresponding to the same transmitting/receiving beam, four random access preambles are generated corresponding to the respective index values, so eight random access preambles may be generated by the index value and the cyclic shift value. The terminals belonging to the same transmitting/receiving beam arbitrarily select one of the eight generated random access preambles and transmit the same.

The base station 100 does not know which random access preamble the terminal may transmit, so it generates random access preambles by the index value and the cyclic shift value, and uses the same to detect the random access preamble. When the terminals belonging to the same transmitting/receiving beam region in the same sub-region use the same index to attempt a random access, the collision that may occur during the random access process of the terminals provided in the same receiving beam region may be minimized by the cyclic shift value.

When receiving the PRACH from the terminals 200₁, 200₂, and 200₃ belonging to a specific sub-region (e.g., sub-regions (Aa and Ac)), the base station 100 detects a random access preamble, and uses the detected random access preamble to determine a transmitting/receiving beam ID to which the terminals 200₁, 200₂, and 200₃ belong, and an index used to generate the random access preamble and a timing alignment (TA) value used to control uplink timing.

Referring to FIG. 3B, the base station 100 transmits an RAR message to the terminals 200₁, 200₂, and 200₃ belonging to the corresponding sub-regions (Aa and Ac) through the transmitting beams (Ba, Bb, Bc, Bf, and Bg) of the sub-regions (Aa and Ac) in response to the random access preamble (S318) and (S320). The base station 100 may transmit information on the terminal for receiving the RAR message and control information such as downlink resource allocation to the terminals 200₁ and 200₂ belonging to the corresponding sub-region (Aa) through the transmitting beams (Ba, Bb, and Bc) of the sub-region (Aa).

The RAR message includes a transmitting/receiving beam ID to which the terminal belongs, an index used for generating the random access preamble and a TA value used for controlling uplink timing, a cell-radio network temporary identifier (C-RNTI), and uplink resource allocation information (UL Grant).

When succeeding in receiving control information such as downlink resource allocation from the base station 100, the terminals 200₁, 200₂, and 200₃ receive the RAR message using the control information.

When receiving a valid RAR message, the terminals 200₁, 200₂, and 200₃ control uplink timing using the TA value (S322), and transmit a connection request message including ID's of the terminals 200₁, 200₂, and 200₃ through an uplink using an uplink radio resource of the allocated transmitting/receiving beam ID (S324), (S326), and (S328).

When receiving the connection request message including the ID's of the terminal 200₁ and 200₂ through the uplink, the base station 100 generates a contention resolution message including the ID's of the terminals 200₁ and 200₂ received in the connection request message, and transmits the contention resolution message to the terminals 200₁, 200₂, and 200₃ through the same transmitting beam as the receiving beam ID having received the connection request message (S330), (S332), and (S334).

The terminals 200₁, 200₂, and 200₃ receive the contention resolution message, determine whether it includes their identifiers, and finish the random access process.

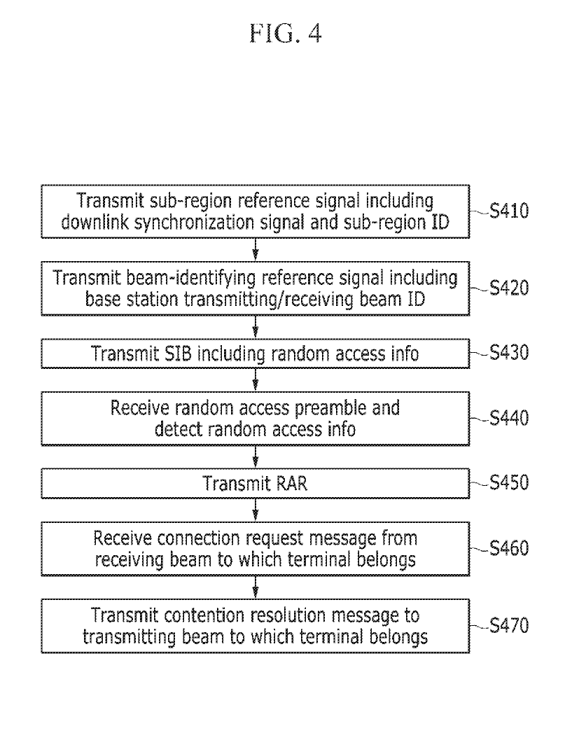

FIG. 4 shows a random access operation by a base station according to an exemplary embodiment of the present invention.

Referring to FIG. 4, the base station 100 transmits a synchronization signal for acquiring downlink synchronization and a sub-region reference signal including information for identifying the sub-regions (S410).

The base station 100 transmits a beam-identifying reference signal for identifying the transmitting/receiving beam provided in the respective sub-regions (S420), and transmits the SIB including random access information of the sub-regions through the transmitting beams of the sub-regions (S430).

When receiving the PRACH from the terminals belonging to the sub-region, the base station 100 detects random access information (S440), and determines the transmitting/receiving beam ID to which the terminal belongs and the index used for generating the random access preamble and the TA value used for controlling uplink timing using the detected random access preamble.

The base station 100 transmits an RAR message including a transmitting/receiving beam ID to which the terminal belongs, the index used for generating the random access preamble, the TA value used for controlling uplink timing, a C-RNTI, and uplink resource allocation information (UL Grant) to the terminal in response to the random access preamble (S450).

Upon receiving a connection request message including an ID of the terminal through the receiving beam according to the transmitted RAR message (S460), the base station 100 generates a contention resolution message including the ID of the terminal received in the connection request message, and transmits the contention resolution message to the terminal through the transmitting beam with the same ID as the receiving beam ID having received the connection request message (S470).

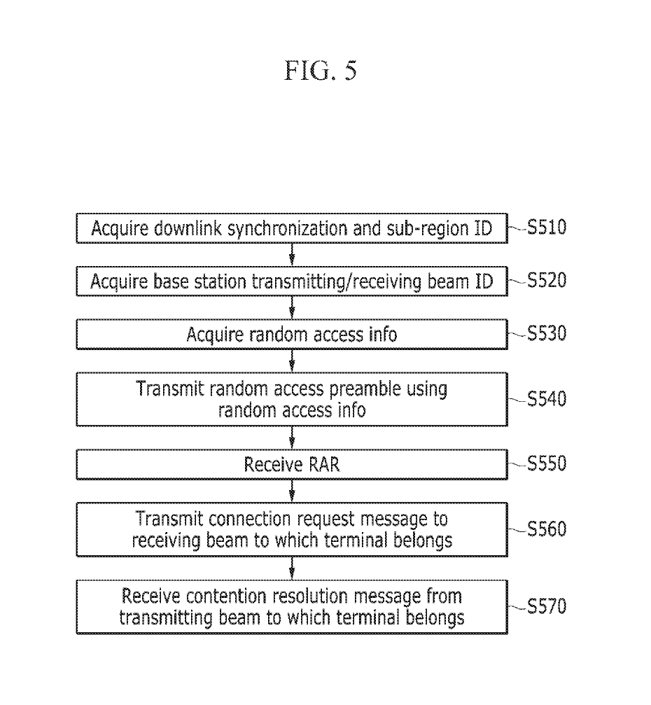

FIG. 5 shows a random access operation by a terminal according to an exemplary embodiment of the present invention.

Referring to FIG. 5, the terminals 200₁, 200₂, and 200₃ perform downlink synchronization when receiving the synchronization signal from the base station 100, and they acquire a sub-region ID using the sub-region reference signal when receiving a sub-region reference signal including sub-region identifying information (S510).

When receiving a beam-identifying reference signal for identifying the transmitting/receiving beams provided in the sub-regions, the terminals 200₁, 200₂, and 200₃ acquire a transmitting/receiving beam ID of the base station to which they belong using a beam-identifying reference signal (S520).

When acquiring the sub-region ID and the transmitting/receiving beam ID, the terminals 200₁, 200₂, and 200₃ receive the SIB corresponding to the sub-region ID, and acquire random access information (S530).

The terminals 200₁, 200₂, and 200₃ transmit the random access preamble to the base station 100 using the random access information included in the SIB (S540) and stand by for an RAR message. The terminals 200₁, 200₂, and 200₃ use the random access information included in the SIB to select one of indexes corresponding to the ID of the transmitting/receiving beam to which the terminals 200₁, 200₂, and 200₃ belong, arbitrarily select one of the random access preambles that may be generated by use of the selected index and the cyclic shift value, and transmit it to the base station 100.

When receiving a valid RAR message on the transmitted random access preamble (S550), the terminals 200₁, 200₂, and 200₃ transmit the connection request message including the ID of the terminals to the receiving beam of the base station 100 to which the terminals 200₁, 200₂, and 200₃ belong, using an uplink radio resource of the allocated transmitting/receiving beam ID (S560).

The terminals 200₁, 200₂, and 200₃ receive the contention resolution message including the ID of the terminals 200₁, 200₂, and 200₃ from the transmitting beam of the base station 100 to which the terminals 200₁, 200₂, and 200₃ belong (S570), and finish the random access process.

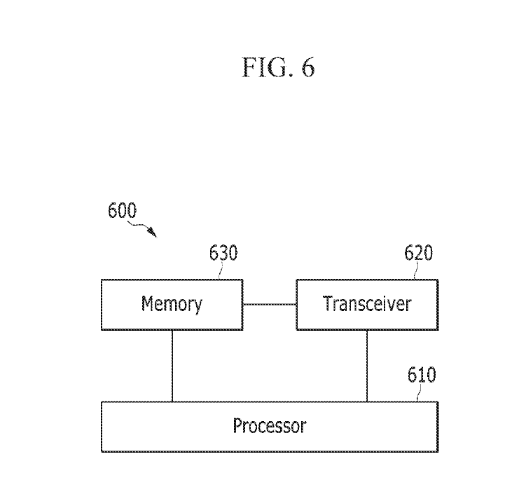

FIG. 6 shows a random access device 600 of a base station according to an exemplary embodiment of the present invention.

Referring to FIG. 6, the random access device 600 of the base station 100 includes a processor 610, a transceiver 620, and a memory 630.

The processor 610 performs the processes described with reference to FIG. 3A, FIG. 3B, and FIG. 4 to process the random access. As described with reference to FIG. 2, the processor 610 use a plurality of transmitting/receiving beams to divide the service region into a plurality of sub-regions including at least one transmitting/receiving beam, and performs the random access process for respective sub-regions. The processor 610 determines random access information in the sub-regions, and transmits the SIB including random access information in the sub-regions to the transceiver 620. The random access information in each sub-region may include an index value allocated to the receiving beam belonging to each sub-region. Further, the processor 610 detects the random access preamble transmitted by the terminal to determine the transmitting/receiving beam ID to which the terminal belongs, the index used for generating the random access preamble, and the TA value used for controlling uplink timing, allocates the uplink resource from the PUSCH of the transmitting/receiving beam ID to which the terminal belongs, generates an RAR based on the random access preamble index and TA information, the transmitting/receiving beam ID, and PUSCH resource allocation information, and transmit the RAR to the transceiver 620.

The transceiver 620 periodically broadcasts the synchronization signal, the sub-region reference signal, and the beam-identifying reference signal through the transmitting beams, broadcasts system information including the SIB and the RAR through the transmitting beams of the sub-regions, and receives the random access preamble from the terminal.

The memory 630 stores instructions to be performed by the processor 610 or receives instructions from a storage device (not shown) and temporarily stores the same, and the processor 610 performs the instructions stored or received in the memory 630.

The processor 610 is connected to the memory 630 through a bus (not shown), and an input/output interface (not shown) may be connected to the bus. The transceiver 620 is then connected to the input/output interface, and peripheral devices such as an input device, a display, a speaker, or a storage device may be connected thereto.

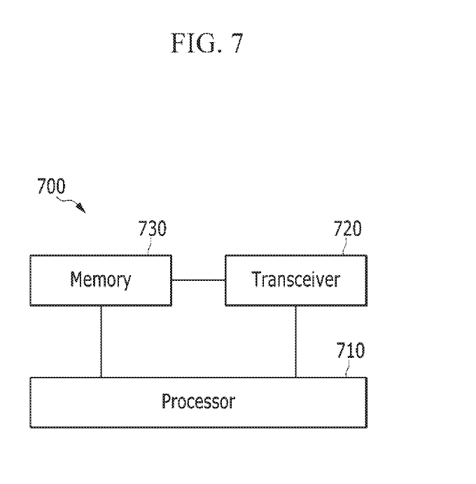

FIG. 7 shows a random access device 700 of a terminal according to an exemplary embodiment of the present invention.

Referring to FIG. 7, the random access device 700 of the terminals 200₁, 200₂, and 200₃ includes a processor 710, a transceiver 720, and a memory 730.

The processor 710 performs the processes described with reference to FIG. 3A, FIG. 3B, and FIG. 5 to perform the random access process. The processor 710 use the synchronization signal transmitted through a plurality of transmitting beams to acquire downlink synchronization, and acquires a sub-region ID and a transmitting/receiving beam ID to which the terminal belongs from the sub-region reference signal and the beam-identifying reference signal transmitted through a plurality of transmitting beams. The processor 710 acquires random access information through the SIB of the sub-region to which the terminal belongs, uses the random access information to generate a random access preamble, and transmits the random access preamble to the transceiver 720. The processor 710 controls uplink timing according to TA information included in the RAR that is a response to the random access preamble, and acquires PUSCH resource allocation information of the transmitting/receiving beam ID instructed by an uplink approval. The processor 710 transmits the connection request message including the ID of the terminal to the transceiver 720, and finishes the random access process when receiving a contention resolution message including the ID of the terminal.

The transceiver 720 transmits the random access preamble through the PRACH, and receives system information including the SIB and an RAR that is a response to the random access preamble from the base station 100. The transceiver 720 uses PUSCH resource allocation information to transmit uplink data. The transceiver 720 transmits the connection request message to the receiving beam of the base station to which the terminal belongs, and receives the contention resolution message from the base station through the transmitting beam of the base station to which the terminal belongs.

The memory 730 stores instructions to be performed by the processor 710 or receives instructions from a storage device (not shown) and temporarily stores the same, and the processor 710 performs the instructions stored or received in the memory 730.

The processor 710 is connected to the memory 730 through a bus (not shown), and an input/output interface (not shown) may be connected to the bus. The transceiver 720 is then connected to the input/output interface, and peripheral devices such as an input device, a display, a speaker, or a storage device may be connected thereto.

According to the exemplary embodiments of the present invention, the delay time when detecting the random access preamble may be minimized and the random access process may be efficiently supported by dividing the service region into sub-regions using the transmitting/receiving beams when base station operates a plurality of transmitting/receiving beams in a service region.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A random access method by a base station for operating a plurality of transmitting/receiving beams in a service region, comprising:
dividing the service region into a plurality of sub-regions by using the plurality of transmitting/receiving beams;
transmitting a system information block including random access information of the sub-regions by using transmitting beams belonging to the respective sub-regions;
detecting a random access preamble transmitted by the terminal by using random access information of the sub-region to which the terminal belongs;
determining a transmitting/receiving beam where the terminal is provided by using the random access preamble; and
transmitting a random access response message including resource allocation information of the transmitting/receiving beam where the terminal is provided to the terminal.

2. The random access method of claim 1, further comprising
transmitting a sub-region reference signal including identifiers of the sub-regions and a beam-identifying reference signal including identifiers of the transmitting/receiving beams provided in the sub-regions.

3. The random access method of claim 1, wherein
random access information of the sub-regions includes at least one index value allocated to the transmitting/receiving beam belonging to the sub-region and at least one cyclic shift value allocated to the terminal, and
the random access preamble is generated by using an index value allocated to the transmitting/receiving beam to which the terminal belongs and the at least one cyclic shift value.

4. The random access method of claim 1, wherein
the detecting includes:
generating random access preamble candidates by using an index value allocated to the transmitting/receiving beam to which the terminal belongs and at least one cyclic shift value allocated to the terminal; and
detecting a random access preamble transmitted by the terminal by using the random access preamble candidates.

5. The random access method of claim 1, wherein
the detecting includes combining a signal received through at least one receiving beam of the sub-region to which the terminal belongs to detect the random access preamble.

6. The random access method of claim 1, further comprising:
receiving the connection request message transmitted by the terminal through the receiving beam of the beam region to which the terminal belongs by using resource allocation information included in the random access response message; and
transmitting the collision resolution message to the terminal through the transmitting beam having a same identifier as the receiving beam.

7. A random access method by a terminal, comprising:
acquiring a sub-region in which the terminal is provided and a transmitting/receiving beam by using transmitting beams belonging to a plurality of sub-regions belonging to a service region of a base station;
receiving a system information block including random access information of the sub-region in which the terminal is provided;
transmitting a random access preamble generated by using random access information of the sub-region in which the terminal is provided; and
receiving a random access response message including resource allocation information of the transmitting/receiving beam to which the terminal belongs from the base station.

8. The random access method of claim 7, wherein
the acquiring includes:
receiving a sub-region reference signal including identifiers of the plurality of sub-regions and a beam-identifying reference signal including identifiers of transmitting/receiving beams in the sub-regions from the base station; and
acquiring an identifier of the sub-region in which the terminal is provided and an identifier of the transmitting/receiving beam by using the sub-region reference signal and the beam-identifying reference signal.

9. The random access method of claim 7, wherein
the transmitting of a random access preamble includes:
determining random access information of a system information block corresponding to the identifier of the sub-region in which the terminal is provided; and
selecting a random access preamble from among at least one random access preamble candidate generated by use of an index value allocated to the identifier of the transmitting/receiving beam where the terminal is provided by using the random access information.

10. The random access method of claim 9, wherein
the random access information further includes at least one cyclic shift value, and
the selecting includes generating the at least one random access preamble candidate by using the index value and the at least one cyclic shift value.

11. The random access method of claim 9, wherein
the generating further includes generating the random access preamble by using a Zadoff-Chu (ZC) sequence.

12. The random access method of claim 7, further comprising
transmitting a connection request message to the receiving beam where the terminal is provided by using resource allocation information included in the random access response message; and
receiving a collision resolution message from the base station.

13. A random access device for a base station operating a plurality of transmitting/receiving beams in a service region, comprising:
a processor for dividing the service region into a plurality of sub-regions by using the plurality of transmitting/receiving beams, determining random access information of the sub-regions, determining a transmitting/receiving beam where the terminal is provided by using the random access preamble transmitted by the terminal based on random access information of the sub-region where the terminal is provided, and generating a random access response message including resource allocation information of the transmitting/receiving beam to which the terminal belongs; and
a transceiver for transmitting random access information of the sub-regions through transmitting beams of the sub-regions, receiving the random access preamble from the terminal, and transmitting the random access response message to the terminal.

14. The random access device of claim 13, wherein
the processor identifies usable indexes for respective sub-regions, identifies the indexes of the sub-regions for respective receiving beams provided in the sub-regions, and generates a system information block of the sub-regions including an index value identified for receiving beams of the regions and at least one cyclic shift value allocated to the terminal, and
the transceiver transmits the system information block of the sub-regions through transmitting beams of the sub-regions.

15. The random access device of claim 14, wherein
the processor generates a sub-region reference signal including identifiers of the sub-regions and a beam-identifying reference signal including identifiers of the transmitting/receiving beams provided in the sub-regions,
the transceiver transmits the sub-region reference signal and the beam-identifying reference signal to the terminal, and
the random access preamble is generated by using an index value allocated to the transmitting/receiving beam to which the terminal belongs and the at least one cyclic shift value.

16. The random access device of claim 15, wherein
the processor determines the sub-region and the transmitting/receiving beam to which the terminal belongs based on an index value corresponding to the random access preamble.
